(19) United States
(12) Patent Application Publication
(10) Pub. No.: US 2007/0091206 A1
(43) Pub. Date: Apr. 26, 2007

(54) Methods, systems and computer program products for accessing downloadable content associated with received broadcast content

(76) Inventor: L. Scott Bloebaum, Cary, NC (US)

Correspondence Address: MYERS BIGEL SIBLEY & SAJOVEC, P.A., P.O. BOX 37428, RALEIGH, NC, 27627, US

(21) Appl. No.: 11/257,942

(22) Filed: Oct. 25, 2005

(51) Int. Cl. H04N 7/00

(52) U.S. Cl. 348/460

(57) ABSTRACT

Methods of accessing downloadable content associated with a time scheduled broadcast media source include receiving the broadcast media source during its associated scheduled broadcast time. An identification of the downloadable content obtained, for example, by extracting the identification from the received broadcast media source. The downloadable content is accessed based on the identification extracted from the broadcast media source. For example, the broadcast media source may be a multicast Internet Protocol (IP) radio and/or television signal and the identification may be extracted from an IP packet included in the multicast IP radio and/or television signal having a header identification indicating identification information content in the IP packet. The downloadable content may be, for example, a podcast.

### BACKGROUND OF THE INVENTION

The present invention relates to communications devices and more particularly, to communications devices including broadcast media tuning features and methods and computer program products for operating the same.

Smart devices such as personal computers and the like are now generally provided with communications capabilities. For example, most such devices are provided with wired or wireless access to the Internet to allow for downloading and viewing of content from Internet Service Providers (ISPs), electronic mail (email) communications and the like. In addition, such devices are often also configured for presenting other forms of media such as music or video. The music or video media content may be received by a tuner, separate from the Internet access, that is configured to receive over air scheduled broadcast media sources, such as radio or television. In addition, some scheduled broadcast media sources are now available over the Internet and, thus, may be received by the smart devices even without the use of a separate over air tuner.

Mobile devices, such as mobile terminals, are increasingly being provided with capabilities that were previously found only in personal computers and the like. Mobile terminals are, typically, primarily purchased by a user to obtain access to wireless phone services through a cellular network telecommunications provider. However, as the processing capabilities, memory and the like included in such mobile terminals increases, an additional level of user functionality is being packaged in such mobile terminals to leverage the benefit to a user of an electronic device that is typically kept with the user at most times. For example, many mobile terminals are currently provided with a camera, allowing pictures to be taken by a user and transmitted from the mobile terminal to others. The mobile terminal may be configured for Internet communications using, for example, the Wireless Application Protocol (WAP). Many mobile terminals also include messaging capability, such as electronic mail (e-mail), short message service (SMS) and multimedia message service (MMS) capabilities.

Another area where additional user functionality is being considered for inclusion in mobile terminals relates to the reception of scheduled broadcast media content from different broadcast media sources. For example, a mobile terminal may be provided with a radio tuner capability so as to receive amplitude modulation (AM) and/or frequency modulation (FM) broadcast radio channels by tuning to the station identifier for the radio station of a particular broadcast media source. In addition, protocols have been proposed for transmission of digital television signals, including both video and audio content, to wireless devices, such as mobile terminals. Accordingly, mobile terminals have been proposed that would be configured to be able to receive and display scheduled television programming based on tuning to an associated station identifier of a broadcast television media source.

### SUMMARY OF THE INVENTION

In some embodiments of the present invention, computer implemented methods of accessing downloadable content associated with a time scheduled broadcast media source include receiving the broadcast media source during its associated scheduled broadcast time. An identification of the downloadable content obtained, for example, by extracting the identification from the received broadcast media source. The downloadable content is accessed based on the identification extracted from the broadcast media source. The extraction and accessing of the downloadable content may be carried out automatically. For example, the broadcast media source may be a multicast Internet Protocol (IP) radio and/or television signal and the identification may be extracted from an IP packet included in the multicast IP radio and/or television signal having a header identification indicating identification information content in the IP packet. The downloadable content may be, for example, a podcast.

In other embodiments of the present invention, the broadcast media source is a broadcast radio signal including Radio Data System (RDS) digital information and the identification is extracted from the RDS digital information. The broadcast media source may be a broadcast digital television signal and the identification may be extracted from the broadcast digital television signal during time slots not including media content of the digital television signal. The received broadcast media source may include an embedded Really Simple Syndication (RSS) feed and the identification may be extracted from the RSS feed.

In further embodiments of the present invention, receiving the broadcast media source includes presenting the received broadcast media source to a user and accessing the downloadable content includes pausing presenting the received broadcast media source to the user and presenting the downloadable content to the user while presenting of the received broadcast media content to the user is paused. Pausing presenting the received broadcast media source may include redirecting the received broadcast media source to a personal media recorder associated with the user and presenting the downloadable content to the user may be followed by presenting the redirected broadcast media source from the personal media recorder to the user.

In other embodiments of the present invention, accessing the downloadable content is preceded by notifying the user of availability of the downloadable content and receiving a designation of desired delivery of the downloadable content from the user responsive to notifying the user. The designation of desired delivery may designate immediate delivery, delayed delivery or no delivery of the downloadable content. Pausing presenting the received broadcast media source and presenting the downloadable content may be carried out responsive to receiving designation of immediate delivery and presenting the downloadable content to the user may be carried out without pausing presenting the received broadcast media source after completing presenting the received broadcast media source to the user responsive to designation of delayed delivery.

In yet other embodiments of the present invention, accessing the downloadable content is preceded by retrieving stored configuration information associated with the user and determining a designation of desired delivery of the downloadable content from the retrieved configuration information. Pausing presenting the received broadcast media source and presenting the downloadable content may be carried out responsive to designation of immediate delivery and presenting the downloadable content to the user may be carried out without pausing presenting the received broadcast media source after completing presenting the received broadcast media source to the user responsive to designation of delayed delivery.

In further embodiments of the present invention, the downloadable content has an associated type and the configuration information includes a plurality of designations of desired delivery, ones of which are associated with corresponding types of downloadable content. Retrieving configuration information includes determining the associated type of the downloadable content and retrieving one of the plurality of designations of desired delivery associated with the determined associated type.

In yet other embodiments of the present invention, the broadcast media source is received by a communication device and receiving the broadcast media source and extracting the identification information are carried out by a media player module executing on the communication device. Accessing the downloadable content is carried out by a browser module executing on the communication device. In such embodiments, the method may further include providing the identification extracted from the received broadcast media source to the browser module from the media player module. The identification extracted from the received broadcast media source may be provided to the browser module from the media player module using a designated application programming interface (API) of the browser module. Execution of the browser module may be initiated responsive to extracting the identification of the downloadable content. The browser module may be a plurality of browser modules, ones of which are associated with respective types of downloadable content. Initiating execution of the browser module may include determining the associated type of the downloadable content and launching a selected one of the plurality of browser modules with the determined associated type of the downloadable content.

In some embodiments of the present invention, the downloadable content is a podcast. Receiving the broadcast media source includes receiving the broadcast media source at a first receiver device and accessing the downloadable media content includes initiating delivery of the podcast to a second receiver device remote from the first receiver device.

In yet further embodiments of the present invention, methods of accessing downloadable content associated with a time scheduled broadcast media source include receiving the broadcast media source during its associated scheduled broadcast time and presenting the received broadcast media source to a user during its associated scheduled broadcast time. An identification of the downloadable content is received while presenting the broadcast media source. Presenting of the received broadcast media source to the user is paused responsive to receiving the identification of the downloadable content. The received broadcast media source is redirected to a personal media recorder associated with the user while presenting of the received broadcast media content to the user is paused. The downloadable content is retrieved based on the received identification and the retrieved downloadable content is presented to the user while presenting of the received broadcast media content to the user is paused. The broadcast media source redirected to the personal media recorder is presented to the user after presenting the retrieved downloadable content to the user.

In yet other embodiments of the present invention, mobile terminals include a portable housing, an output device in the housing, a wireless communication network interface circuit in the housing configured to request and receive downloadable content, a receiver in the housing configured to receive a time scheduled broadcast media source and a controller in the housing. The controller is configured to execute a media player module configured to present the time scheduled broadcast media source on the output device and a browser module configured to request the downloadable content using the wireless communication network interface based on an identification of the downloadable content and present the downloadable content on the output device. The controller is further configured to execute an access control module configured to extract the identification of the downloadable media content from the received broadcast media source and provide the extracted identification to the browser module to initiate requesting of the downloadable content by the browser module.

In further embodiments, the access control module is configured to pause presenting of the broadcast media source on the output device while the downloadable content is presented on the output device. The access control module may be configured to initiate redirection of the broadcast media source to a personal recorder associated with a user of the mobile terminal while presenting of the broadcast media source is paused and to initiate presenting of the redirected broadcast media source from the personal recorder by the media player module after the downloadable content is presented on the output device. A user input device in the housing may be configured to receive a user designation of desired delivery of the downloadable content and the access control module may be configured to control timing of presentation of the broadcast media source and the downloadable content based on the designation of desired delivery. The broadcast media source may be a multicast Internet Protocol (IP) television signal and the downloadable content may be a podcast. The output device may be a display and a speaker and the access control module may be configured to extract the identification from an IP packet included in the multicast IP television signal having a header identification indicating identification information content in the IP packet.

In other embodiments of the present invention, methods of identifying downloadable content in a time scheduled broadcast media source include determining an identification of the downloadable content configured to provide a receiving device access to the downloadable content. The identification of the downloadable content is inserted in the time scheduled media source and the time scheduled broadcast media source is communicated to receiving devices during its associated scheduled broadcast time.

In further embodiments of the present invention, signal transmission medium having a signal embodied therein is provided. The signal includes a time scheduled broadcast media source with an embedded identification of downloadable content.

While described above primarily with reference to apparatus and method aspects, it will be understood that the present invention also includes computer program products for a mobile terminal and communication devices.

### BRIEF DESCRIPTION OF THE DRAWINGS

FIG. 1 is a schematic block diagram of a communication device according to some embodiments of the present invention and an exemplary over air scheduled broadcast media source and Internet information sources.

FIG. 2 is a schematic block diagram of a mobile terminal according to some embodiments of the present invention and an exemplary base station transceiver and broadcast media source.

FIGS. 3 to 6 are flowcharts illustrating methods of accessing downloadable content identified in a time scheduled broadcast media source according to some embodiments of the present invention.

### DETAILED DESCRIPTION OF EXEMPLARY EMBODIMENTS

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular exemplary embodiments illustrated in the accompanying drawings is not intended to be limiting of the invention. In the drawings, like numbers refer to like elements.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, a “mobile terminal” includes both devices having only a wireless signal receiver without transmit abilities and devices having both receive and transmit hardware capable of two-way communication over a two-way communication link. Such devices may include cellular or other communications devices with or without a multi-line display; Personal Communications System (PCS) terminals that may combine a voice and data processing, facsimile and/or data communications capabilities; Personal Digital Assistants (PDA) that can include a radio frequency receiver and a pager, Internet/Intranet access, Web browser, organizer, calendar and/or a global positioning system (GPS) receiver; and/or conventional laptop and/or palmtop computers or other appliances, which include a radio frequency receiver. As used herein, “mobile terminals” may be portable, transportable, installed in a vehicle (aeronautical, maritime, or land-based), or situated and/or configured to operate locally and/or in a distributed fashion at any other location(s) on earth and/or in space. As used herein, a “mobile device” includes mobile terminals as well as mobile devices that do not support wireless communications.

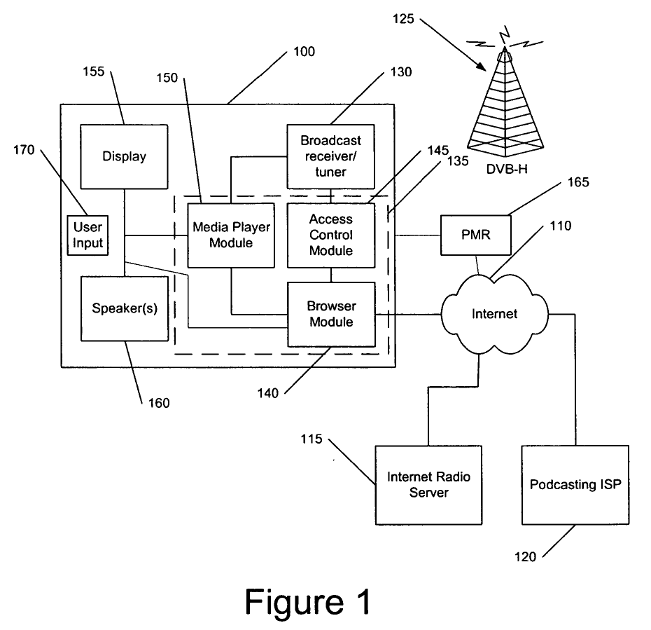

Embodiments of the present invention will now be described below with respect to FIGS. 1 through 6. Referring first to FIG. 1, a system for accessing downloadable content identified in a time scheduled broadcast media source is illustrated. As shown in the embodiments of FIG. 1, a communication device 100 is communicatively coupled to the Internet 110 and a time scheduled broadcast media source 125 illustrated as a digital video broadcasting-handhelds (DVB-H) source in FIG. 1. The communication device 100 includes a controller 135, a broadcast receiver/tuner 130, a display 155 and speaker(s) 160. The controller 135 may request an receive downloadable content over the Internet 110 from sources such as the podcasting Internet service provider (ISP) 120 schematically illustrated in FIG. 1. An Internet radio server 115 may also be coupled to the controller 135 through the Internet 110. The broadcast receiver/tuner 130 is configured to receive a signal from a time scheduled broadcast media source 125. For example, the broadcast receiver/tuner 130 may be a television tuner, amplitude modulation (AM) radio tuner, frequency modulation (FM) radio tuner or the like that may be tuned to a selected channel and receive media programming that is scheduled for delivery during the time while a signal is being received by the broadcast receiver/tuner 130. The display 155 and the speaker(s) 160 provide output devices for rendering of video and/or audio media signals received at a communications device 100.

It will be understood that a time scheduled broadcast media source may be received by the broadcast receiver/tuner 130 as an over air signal and/or, in some cases, received from an Internet radio (or television) server 115 that delivers such time scheduled broadcast content using an Internet based protocol rather than a conventional over air transmission. In any event, the Internet radio (or television) server 115 may be distinguished from the podcasting ISP 120 in that the available content is transmitted based on a determinant time scheduled basis rather than being available on demand or by subscription to a user as with the podcasting ISP 120 contents.

For the embodiments illustrated in FIG. 1, the controller 135 is configured to execute the media player module 150, the browser module 140 and the access control module 145. The media player module 150 is configured to present the time scheduled broadcast media source on the display 155 and/or speaker(s) 160. The browser module 140 is configured to request downloadable content, such as from the podcasting ISP 120, based on an identification of the downloadable content and to present the downloadable content on the display 155 and/or speaker(s) 160. In some embodiments of the present invention, as will be described herein, the identification may be received in the broadcast media source.

The access control module 145 is configured in some embodiments of the present invention to extract the identification of the downloadable media content from the received broadcast media source. The access control module 145 is further configured to provide the extracted identification to the browser module 140 to initiate requesting of the downloadable content by the browser module 140.

For example, the identification may be an Internet address for a particular podcast available from the podcasting ISP 120. The extracted Internet address may be passed to the browser module 140. For example, the extracted identification may be provided to the browser module 140 using a designated application programming interface (API) of the browser module 140. The access control module 145 may further initiate execution of the browser module 140 responsive to extracting the identification of the downloadable content and pass the identification after initiating execution of the browser module 140 or concurrently with initiating execution of the browser module 140. It will be understood that, while the description herein is based on the illustrated access control module 145 being separate from the media player module 150, the media player module 150 itself may be configured to include the functionality described for the access control module 145 so as to be able to extract the identification. The illustrated modules are generally illustrated schematically as being executed by a controller 135, and various of the functionalities herein may be otherwise divided in different manners than as described above. Furthermore, the functionality described may be spread across multiple controllers within the communication device 100.

It will be understood that, while a single browser module 140 is illustrated in the embodiments of FIG. 1, a variety of different types of downloadable content may be available and ones of the different types of downloadable content may use different ones of a plurality of browser modules available for execution on the communication device 100. Accordingly, a plurality of different browser modules 140 suited for different types of downloadable content may be executed by the controller 135.

The access control module 145 may further be configured to pause presenting of the broadcast media source on the display 155 and/or speaker(s) 160 while the downloadable content is presented on the display 155 and/or speaker(s) 160. In some embodiments, the access control module 145 is configured to redirect the broadcast media source to a personal media recorder 165 associated with a user of the communications device 100 while presenting of the broadcast media source is paused. For example, the access control module 145 may initiate redirection of the broadcast media source by sending signals to the mobile TV server (or other source of the content) via the wireless network. In other words, the redirected content may not need to be received and re-sent by the access control module 145. The access control module 145 may further be configured to initiate presenting of the redirected broadcast media source from the personal media recorder 165 by the media player module 150 after the downloadable content has been presented. For example, the PMR recording of the broadcast media source may be delivered by point-to-point streaming over the cellular network and may be combined with the content from the broadcast network for the presentation to the user.

As further shown in FIG. 1, a user input device 170 may be provided for the communication device 100. The user input device 170 may be configured to receive a user designation of desired delivery of downloadable content. In such embodiments, the access control module 145 may be configured to control timing of presentation of the broadcast media source and the downloadable content based on the designation of desired delivery received through the user input device 170. Thus, as used herein “desired delivery” may refer to the time/manner of presenting the content to a user and/or the time/manner of downloading of the content for immediate and/or future presentation of the content for viewing by the user.

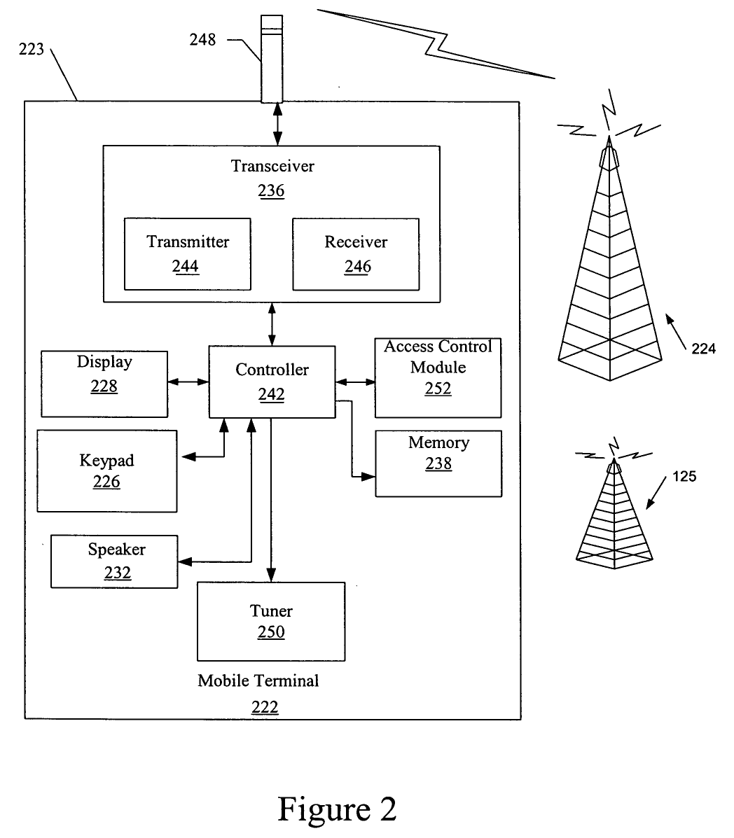

Referring now to FIG. 2, a schematic block diagram is provided illustrating a mobile terminal including media tuning capabilities in accordance with some embodiments of the present invention. FIG. 2 illustrates a mobile terminal 222 and a base station transceiver 224 of a wireless communications network. A time scheduled broadcast media source 125 is also schematically shown, such as a radio station or television station broadcast signal.

The mobile terminal 222 includes a portable housing 223 and may include a keypad 226, a display 228, a speaker 232, a transceiver 236, a memory 238, a broadcast media tuner 250 and an access control module 252, any of which may communicate with a controller (processor) 242. The processor 242 can be any commercially available or custom microprocessor. All or a portion of the broadcast media tuner 250 and/or the access control module 252 may be implemented as software executing on the controller 242.

The transceiver 236 provides a wireless communication network interface circuit that typically includes a transmitter circuit 244 and a receiver circuit 246, which respectively transmit outgoing radio frequency signals to the base station transceiver 224 and receive incoming radio frequency signals, such as voice call and data signals, from the base station transceiver 224 via an antenna 248. The antenna 248 and the transceiver 236 may also be used to receive signals from the broadcast media source 125, in some embodiments of the present invention, or a separate antenna and/or receiver and/or transmitter may be provided. The antenna 248 may be an embedded antenna, a retractable antenna or any antenna known to those having skill in the art. The radio frequency signals transmitted between the mobile terminal 222 and the base station transceiver 224 may include both traffic and control signals (e.g., paging signals/messages for incoming calls), which are used to establish and maintain a voice call communication with another party or to transmit and/or receive data, such as e-mail, SMS and/or MMS messages, with a remote device.

The controller 242 may support various functions of the mobile terminal 222, including functions related to voice communications and data communications, such as a Wireless Application Protocol (WAP) link configured to request and receive downloadable content at the mobile terminal 222 using the base station transceiver 224 according to some embodiments of the present invention. In some embodiments, the media tuner 250 and the access control module 252 are implemented entirely in the controller 242 and the receiver 246.

In some embodiments of the present invention, the base station transceiver 224 is a radio transceiver(s) that defines a cell in a cellular network and communicates with the mobile terminal 222 and other mobile terminals in the cell using a radio-link protocol. Although only a single base station transceiver 224 is shown, it will be understood that many base station transceivers may be connected through, for example, a mobile switching center and other devices, to define a wireless communications network.

In some embodiments, the broadcast media source 125 may be an IP addressable media source being accessed by a user of a mobile terminal 222 using a media player module of the mobile terminal. The controller 242 may be configured to provide a browser module and media player module as generally described previously with reference to FIG. 1. Similarly, the access control module 252 may be configured as generally described with reference to the access control module 145 of FIG. 1.

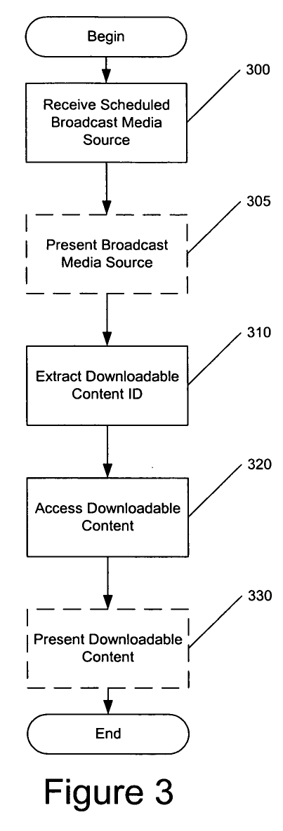

Some embodiments of methods for accessing downloadable content identified in or associated with a time scheduled broadcast media source will now be described with reference to the flowchart illustrations of FIGS. 3-6. Referring first to the embodiments illustrated in FIG. 3, operations begin with receiving the broadcast media source during its associated scheduled broadcast time (block 300). The received broadcast media source may be presented to a user (block 305). An identification of the downloadable content is extracted from the received broadcast media source (block 310).

In some embodiments, the broadcast media source is a multicast Internet protocol (IP) radio and/or television signal and extracting the identification at block 310 includes extracting the identification from an IP packet included in the multicast IP radio and/or television signal and having a header identification indicating identification information content in the IP packet. In further embodiments of the present invention, the broadcast media source is a broadcast radio signal including Radio Data System (RDS) information. Extracting the identification in such embodiments may include extracting the identification from the RDS digital information. In further embodiments of the present invention, the broadcast media source is a broadcast digital television signal and the identification information is extracted from the broadcast digital television signal during time slots not including media content of the digital television signal. In other embodiments links and/or pointers to the downloadable content information may be carried during time slots including media content but differentiated by higher-layer protocol header information within an IP packet. The pointers could also be sent to the mobile terminal or other receiver device over the cellular network and then combined with the content from the broadcast network in the presentation to the user. The received broadcast media source in other embodiments of the present invention includes an embedded Really Simple Syndication (RSS) feed and the identification is extracted from the RSS feed. In some embodiments of the present invention, methods are provided for insertion of the identification in the broadcast media source.

The downloadable content is accessed based on the identification extracted from the broadcast media source (block 320). For example, the downloadable content may be a podcast and the Internet address associated with the podcast may be extracted from the received broadcast media source. The downloadable content may be presented to a user (block 330).

In some embodiments of the present invention, the broadcast media sources received at a first receiver device and the podcast or other downloadable media content is accessed by initiating delivery of the podcast to a second receiver device remote from the first receiver device, such as a home personal computer for later viewing. Thus, broadcast media source presented at block 305 and downloadable content presented at block 330 may be presented, in some embodiments of the present invention, at different devices.

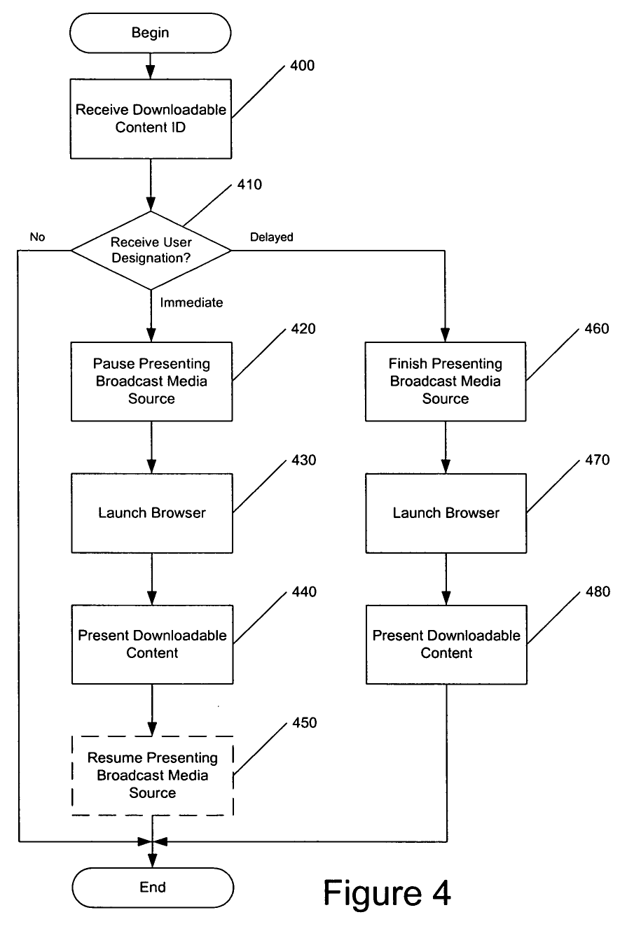

Further embodiments of the present invention will now be described with reference to the flowchart illustration of FIG. 4. As shown in the embodiments of FIG. 4, operations begin at block 400 with the receipt of an identifier of downloadable content. The identifier, as described previously herein, may be received in a time scheduled broadcast media source or otherwise associated therewith. In the embodiments illustrated in FIG. 4, a user may designate an approach to handling of receipt of an identifier for downloadable content at block 400. Thus, operations at block 400 may include notifying the user of availability of the downloadable contents.

A designation of desired delivery of the downloadable content is received from the user responsive to notifying the user (block 410). The designation of desired delivery at block 410 may designate immediate delivery, delayed delivery, or no delivery of the downloadable content as shown in the embodiments of FIG. 4. Where immediate delivery is requested (block 440), presenting of the received broadcast media source to a user is paused (block 420). In some embodiments of the present invention, a browser module is launched, such as by initiating execution of the browser module responsive to receipt of identification of downloadable content (block 430). The identification may be passed to the browser module, for example, using a designated application programming interface (API) of the browser module. The downloadable content is presented to the user while presenting of the received broadcast media content to the user is paused (block 440). The presenting of the broadcast media source to the user may then be resumed in some embodiments of the present invention (block 450).

For the embodiments of FIG. 4, where delayed delivery is designated by the user (block 410), the receiving communication device finishes presenting the broadcast media source to the user (block 460). For example, the user may be viewing a specific scheduled television show and the entirety of that specified television show may be completed before operations move from block 460 to blocks 470 and 480. Once the show is completed, the browser is launched (block 470) and the downloadable content is presented to the user (block 480). In some embodiments, the user may be prompted after the current show is completed to be provided an opportunity to delay delivery further in favor of currently broadcast content. In other embodiments, delayed delivery may commence after user termination of a current viewing regardless of whether the current program has completed. It will be understood that operations related to launching a browser at block 470 may not be executed where the browser application is already launched and the necessary identification may be provided to the already launched browser to obtain the downloadable content for presentation to a user at block 480. Finally, where the user specifies no delivery (block 410), the downloadable content is not presented to the user.

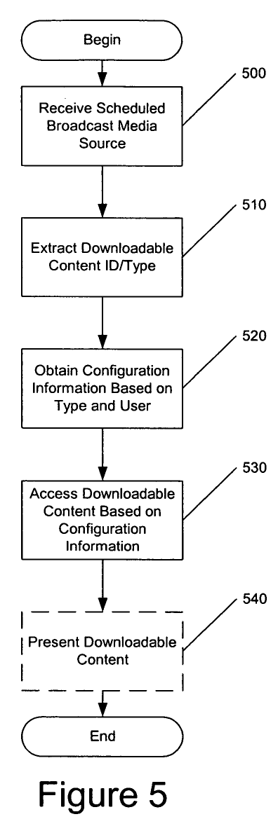

Further embodiments of the present invention will now be described with reference to the flowchart illustration of FIG. 5. For the embodiments illustrated in FIG. 5, operations begin with receiving a scheduled broadcast media source (block 500). For the embodiments illustrated in FIG. 5, a downloadable content identifying the received broadcast media source has an associated type and the identification and associated type of the downloadable content are extracted from the media source (block 510). Configuration information, including designations of desired delivery appropriate for the type of downloadable content, are retrieved based on the determined associated type of the downloadable content and/or based on the user operating the device (block 520). In other words, the configuration information may include a plurality of designations of desired delivery, ones of which are associated with corresponding types of downloadable content. Similarly, different users may have different configuration information for the respective types of downloadable content. The applicable one of the plurality of designations of desired delivery may then be retrieved that is associated with the determined type of downloadable content and/or user.

The downloadable content may then be accessed based on the retrieved configuration information (block 530). For example, the retrieved configuration information may specify no, immediate or delayed delivery and operations may proceed substantially as described with reference to FIG. 4 for embodiments where the designation is received by way of user input rather than configuration information. The downloadable content may then be presented to a user in accordance with the configuration information (block 540).

It will be further understood that utilization of configuration information rather than a user designation in determining the form of delivery of the downloadable content may be provided in embodiments such as illustrated in FIG. 4 where the downloadable content may not have an associated type and the configuration information is based on the user requesting delivery of the downloadable content. It will further be understood that the associated type of downloadable content in the embodiments of FIG. 5 may identify one of a plurality of browser modules available in the receiving communication device that is the browser module to be used for accessing a particular type of downloadable content. As such, a selected one of the browser modules may be launched where the browser module is selected based on its association with the determined associated type of the downloadable content that is to be accessed.

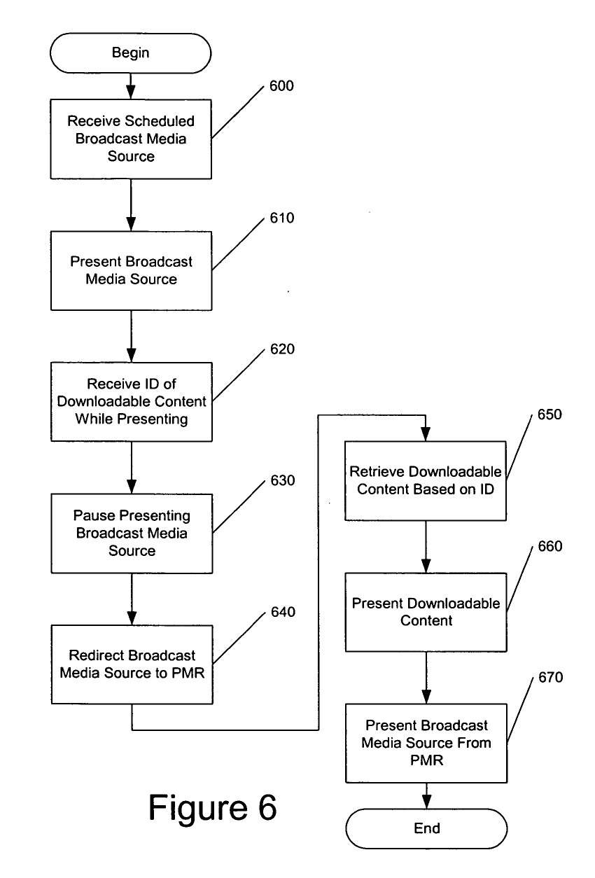

Methods for accessing downloadable content associated with a time scheduled broadcast media source according to further embodiments of the present invention will now be described with reference to the flowchart illustration of FIG. 6. As seen in FIG. 6, operations begin with receiving the time scheduled broadcast media source during its associated scheduled broadcast time (block 600). The received broadcast media source is presented to a user during its associated scheduled broadcast time (block 610). An identification of the downloadable content is received while presenting the broadcast media source to the user (block 620).

Presenting of the received broadcast media source to the user is paused responsive to receipt of the identification of the downloadable content (block 630). The received broadcast media source is redirected to a personal media recorder associated with the user while presenting of the received broadcast media content to the user is paused (block 640).

The downloadable content is retrieved based on the received identification (block 650). The retrieved downloadable content is presented to the user while presenting of the received broadcast media content to the user is paused (block 660). The broadcast media source that was redirected to the personal media recorder of the user is presented to the user after presenting the retrieved downloadable content to the user (block 670). In some embodiments, the user may be prompted prior to presentation of the material recorded at the PMR.

As described herein, some embodiments of the present invention provide a mobile terminal that presents a user with links or references to downloadable content while presenting a broadcast media source, such as mobile television or the like. The downloadable content may, for example, be a podcast containing commentary or other supplementary material related to the current program on the broadcast media source. The notification of related content in some embodiments may be done by embedding an RSS feed into the broadcast service. The presentation of the broadcast media source in some embodiments may be modified and the podcast may be presented, for example, using a picture-in-picture or split-screen approach for two video sources. The user may be presented with the option of pausing the presenting of the broadcast by, for example, redirecting it to a personal video recording service of the user, while downloading and immediately consuming the related downloadable content. The user may also have the option of continuing to watch the broadcast content while downloading the related content in the background and, for example, storing it for later consumption. The user may also be given the option of redirecting the podcast or other downloadable content to another device (such as a personal computer) for later synchronization or viewing.

As will be appreciated by one of skill in the art, the present invention may be embodied as a method, system, or computer program product. Accordingly, the present invention may take the form of an entirely hardware embodiment, a software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language and/or a lower level assembler language. The program code may execute entirely on the user's computer (i.e., controller of the user's mobile terminal), partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Furthermore, the present invention was described in part above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowchart and schematic diagrams of FIGS. 1-6 illustrate the architecture, functionality, and operations of some embodiments of methods, systems, and computer program products for accessing downloadable content that may be identified by and/or associated with a time scheduled broadcast media source. In this regard, each block may represent a module, segment, or portion of code, which comprises one or more executable instructions for implementing the specified logical function(s). It should also be noted that in other implementations, the function(s) noted in the blocks may occur out of the order noted in the figures. For example, two blocks shown in succession may, in fact, be executed substantially concurrently or the blocks may sometimes be executed in the reverse order, depending on the functionality involved.

In the drawings and specification, there have been disclosed exemplary embodiments of the invention. Although specific terms are employed, they are used in a generic and descriptive sense only and not for purposes of limitation, the scope of the invention being defined by the following claims.

That which is claimed is:

1. A computer implemented method of accessing downloadable content associated with a time scheduled broadcast media source, comprising:
receiving the broadcast media source during its associated scheduled broadcast time;
obtaining an identification of the downloadable content; and
accessing the downloadable content based on the identification extracted from the broadcast media source.

2. The method of claim 1, wherein obtaining the identification of the downloadable content comprises extracting an identification of the downloadable content from the received broadcast media source

3. The method of claim 2, wherein the broadcast media source comprises a multicast Internet Protocol (IP) radio and/or television signal and wherein extracting the identification comprises extracting the identification from an IP packet included in the multicast IP radio and/or television signal having a header identification indicating identification information content in the IP packet.

4. The method of claim 2, wherein the broadcast media source comprises a broadcast radio signal including Radio Data System (RDS) digital information and wherein extracting the identification comprises extracting the identification from the RDS digital information.

5. The method of claim 2, wherein the broadcast media source comprises a broadcast digital television signal and wherein extracting the identification comprises extracting the identification from the broadcast digital television signal during time slots not including media content of the digital television signal.

6. The method of claim 2, wherein the received broadcast media source includes an embedded Really Simple Syndication (RSS) feed and wherein extracting the identification comprises extracting the identification from the RSS feed.

7. The method of claim 2, wherein the downloadable content comprises a podcast.

8. The method of claim 2, wherein receiving the broadcast media source includes presenting the received broadcast media source to a user and wherein accessing the downloadable content comprises:
modifying presentation of the received broadcast media source to the user; and
presenting the downloadable content to the user while presenting of the received broadcast media content to the user is paused.

9. The method of claim 8, wherein modifying presentation of the received broadcast media source comprises pausing presenting the received broadcast media source and redirecting the received broadcast media source to a personal media recorder associated with the user and wherein presenting the downloadable content to the user is followed by presenting the broadcast media source redirected to the personal media recorder to the user.

10. The method of claim 8, wherein accessing the downloadable content is preceded by:
notifying the user of availability of the downloadable content; and
receiving a designation of desired delivery of the downloadable content from the user responsive to notifying the user, wherein the designation of desired delivery designates immediate delivery, delayed delivery or no delivery of the downloadable content and:
wherein modifying presentation of the received broadcast media source and presenting the downloadable content are carried out responsive to receiving designation of immediate delivery; and
wherein presenting the downloadable content to the user is carried out without modifying presentation of the received broadcast media source after completing presenting the received broadcast media source to the user responsive to designation of delayed delivery.

11. The method of claim 8, wherein accessing the downloadable content is preceded by:
retrieving stored configuration information associated with the user; and
determining a designation of desired delivery of the downloadable content from the retrieved configuration information, wherein the designation of desired delivery designates immediate delivery, delayed delivery or no delivery of the downloadable content and:
wherein modifying presentation of the received broadcast media source and presenting the downloadable content are carried out responsive to designation of immediate delivery; and
wherein presenting the downloadable content to the user is carried out without modifying presentation of the received broadcast media source after completing presenting the received broadcast media source to the user responsive to designation of delayed delivery.

12. The method of claim 11, wherein the downloadable content has an associated type and wherein the configuration information includes a plurality of designations of desired delivery, ones of which are associated with corresponding types of downloadable content and wherein retrieving configuration information includes determining the associated type of the downloadable content and retrieving one of the plurality of designations of desired delivery associated with the determined associated type.

13. The method of claim 2, wherein the broadcast media source is received by a communication device and wherein receiving the broadcast media source and extracting the identification information are carried out by a media player module executing on the communication device and accessing the downloadable content is carried out by a browser module executing on the communication device and wherein the method further comprises providing the identification extracted from the received broadcast media source to the browser module from the media player module.

14. The method of claim 13, wherein the identification extracted from the received broadcast media source is provided to the browser module from the media player module using a designated application programming interface (API) of the browser module.

15. The method of claim 13, wherein the method further comprises initiating execution of the browser module responsive to extracting the identification of the downloadable content.

16. The method of claim 15, wherein the downloadable content has an associated type and wherein the browser module comprises a plurality of browser modules, ones of which are associated with respective types of downloadable content and wherein initiating execution of the browser module includes determining the associated type of the downloadable content and launching a selected one of the plurality of browser modules with the determined associated type of the downloadable content.

17. The method of claim 2, wherein the downloadable content comprises a podcast and wherein receiving the broadcast media source comprises receiving the broadcast media source at a first receiver device and wherein accessing the downloadable media content includes initiating delivery of the podcast to a second receiver device remote from the first receiver device.

18. A computer program product for accessing downloadable content identified in a time scheduled broadcast media source, the computer program product comprising computer program code embodied in a computer readable medium, the computer program code comprising program code configured to carry out the method of claim 2.

19. A communication device configured to carry out the method of claim 2.

20. A mobile terminal configured to carry out the method of claim 2.

21. A computer implemented method of accessing downloadable content associated with a time scheduled broadcast media source, comprising:
receiving the broadcast media source during its associated scheduled broadcast time;
presenting the received broadcast media source to a user during its associated scheduled broadcast time;
receiving an identification of the downloadable content while presenting the broadcast media source;
pausing presenting the received broadcast media source to the user responsive to receiving the identification of the downloadable content;
redirecting the received broadcast media source to a personal media recorder associated with the user while presenting of the received broadcast media content to the user is paused;
retrieving the downloadable content based on the received identification;
presenting the retrieved downloadable content to the user while presenting of the received broadcast media content to the user is paused; and
presenting the broadcast media source redirected to the personal media recorder to the user after presenting the retrieved downloadable content to the user.

22. A computer program product for accessing downloadable content associated with a time scheduled broadcast media source, the computer program product comprising computer program code embodied in a computer readable medium, the computer program code comprising program code configured to carry out the method of claim 21.

23. A communication device configured to carry out the method of claim 21.

24. A mobile terminal configured to carry out the method of claim 21.

25. A mobile terminal, comprising:
a portable housing;
an output device in the housing;
a wireless communication network interface circuit in the housing configured to request and receive downloadable content;
a receiver in the housing configured to receive a time scheduled broadcast media source; and
a controller in the housing configured to execute:
a media player module configured to present the time scheduled broadcast media source on the output device;
a browser module configured to request the downloadable content using the wireless communication network interface based on an identification of the downloadable content and present the downloadable content on the output device; and
an access control module configured to extract the identification of the downloadable media content from the received broadcast media source and provide the extracted identification to the browser module to initiate requesting of the downloadable content by the browser module.

26. The mobile terminal of claim 25, wherein the access control module is configured to pause presenting of the broadcast media source on the output device while the downloadable content is presented on the output device.

27. The mobile terminal of claim 26, wherein the access control module is configured to redirect the broadcast media source to a personal recorder associated with a user of the mobile terminal while presenting of the broadcast media source is paused and to initiate presenting of the redirected broadcast media source from the personal recorder by the media player module after the downloadable content is presented on the output device.

28. The mobile terminal of claim 26, further comprising a user input device in the housing configured to receive a user designation of desired delivery of the downloadable content and wherein the access control module is configured to control timing of presentation of the broadcast media source and the downloadable content based on the designation of desired delivery.

29. The mobile terminal of claim 26, wherein the broadcast media source comprises a multicast Internet Protocol (IP) television signal and the downloadable content comprises a podcast and the output device comprises a display and a speaker and wherein the access control module is configured to extract the identification from an IP packet included in the multicast IP television signal having a header identification indicating identification information content in the IP packet.

30. A computer implemented method of identifying downloadable content in a time scheduled broadcast media source, comprising:
determining an identification of the downloadable content configured to provide a receiving device access to the downloadable content;
inserting the identification of the downloadable content in the time scheduled media source; and
communicating the time scheduled broadcast media source to receiving devices during its associated scheduled broadcast time.

31. The method of claim 30, wherein the broadcast media source comprises a multicast Internet Protocol (IP) radio and/or television signal and wherein inserting the identification comprises inserting the identification in an IP packet included in the multicast IP radio and/or television signal having a header identification indicating identification information content in the IP packet.

32. The method of claim 30, wherein the broadcast media source comprises a broadcast radio signal including Radio Data System (RDS) digital information and wherein inserting the identification comprises inserting the identification in the RDS digital information.

33. The method of claim 30, wherein the broadcast media source comprises a broadcast digital television signal and wherein inserting the identification comprises inserting the identification in the broadcast digital television signal during time slots not including media content of the digital television signal.

34. The method of claim 30, wherein the received broadcast media source includes an embedded Really Simple Syndication (RSS) feed and wherein inserting the identification comprises inserting the identification in the RSS feed.

35. A signal transmission medium having a signal embodied therein, the signal comprising a time scheduled broadcast media source with an embedded identification of downloadable content.
